(19) United States
(12) Patent Application Publication
(10) Pub. No.: US 2012/0301248 A1
(43) Pub. Date: Nov. 29, 2012

(54) System and Method for Fastening Objects Together

(75) Inventors: Benjamin Arnold, San Diego, CA (US); Farshid Dilmaghanian, Rancho Santa Margarita, CA (US); Jeffrey Frederick, Manhattan Beach, CA (US); Robert Valdez, Rancho Santa Margarita, CA (US)

(73) Assignee: NuVasive, Inc., San Diego, CA (US)

(21) Appl. No.: 13/347,645

(22) Filed: Jan. 10, 2012

Related U.S. Application Data
(63) Continuation of application No. 13/115,819, filed on May 25, 2011, now abandoned.
Application No. 13/115,819 is a continuation of application No. 12/937,356, now abandoned.

(51) Int. Cl. F16B 21/00; B23P 11/00

(52) U.S. Cl. 411/347; 29/525.03

(57) ABSTRACT

A fastener device for fastening two or more objects together, and more particularly a fastener device of the type that incorporates a pin having an undulating section and a corresponding mating housing having a resilient biasing member for fixing the mating housing along a desired position on the pin. The mating housing can be caused to permanently lock onto the pin or can be removable from the pin.

### CROSS REFERENCES TO RELATED APPLICATIONS

The present application is a continuation of U.S. patent application Ser. No. 13/115,819, filed May 25, 2011, now pending, which is a continuation of U.S. patent application Ser. No. 12/937,356, filed Oct. 11, 2010, abandoned, which claims the benefit of priority under 35 U.S.C. §119(e) from U.S. Provisional Patent Application Ser. No. 61/123,783, filed on Apr. 11, 2008, the entire contents of which is hereby expressly incorporated by reference into this disclosure as if set forth fully herein.

### BACKGROUND OF THE INVENTION

I. Field of the Invention

Fasteners are generally discussed herein for fastening two or more objects together and more particularly to fasteners of the type that incorporate a pin having a serrated section and a corresponding mating housing having a resilient biasing member for fixing the pin.

II. Discussion of the Prior Art

Fasteners are well known in the art for securing two or more objects together include screws, bolts and nuts combination, rivets and the like. While prior art fasteners continue to be used for fastening two or more objects together, there remains a need for improved fastening devices for everyday and specialty applications.

### SUMMARY OF THE INVENTION

According to one broad aspect of the present invention, the fastener device described herein comprises a pin, a corresponding mating housing, and a canted coil spring member. The pin includes a pin head, a first shank section, and a second shank section between the pin head and the first shank section. In one exemplary embodiment, the first shank section is generally serrated and includes a frustoconical tip for facilitating insertion into the mating housing. The serration is formed by two or more spaced apart flanges or threads on the first shank section, which define a plurality of grooves for mating engagement with the mating housing, as further discussed below. The first flange is preferably integrated with the frustoconical section. An alternative pin may be provided that incorporates a plurality of sloped recessed sections in between two adjacent flanges. The sloped recessed sections facilitate advancement of the mating housing over the pin to engage the two during use. The mating housing may engage with any one of the plurality of grooves to thus provide for a degree of freedom or flexibility when using the fastener to couple two or more objects together of different sizes.

The mating housing generally comprises a housing groove for accommodating the canted coil spring. As is readily apparent to a person of ordinary skill in the art, the mating housing is generally cylindrical in shape and has a hollow cavity resembling a nut. The characteristics of canted coil spring may be manipulated by the geometry of the housing groove. Thus, in accordance with aspects of the present invention, the mating housing may incorporate grooves of different geometries to vary the radial, axial, or both radial and axial forces exerted by the canted coil spring when holding two objects together.

The canted coil spring may be described as a radial canted coil spring and comprises a coil height axis and a coil width axis. The canted coil spring comprises a plurality of coils and is a garter-type-spring with two single coils, one above and one below the pin. The plurality of coils are canted along a same direction relative to a plane normal to a centerline of the spring axis. To couple the mating housing to the pin, the mating housing is pushed over the frustoconical section of the pin to deflect or compress the canted coil spring along the coils' height axes, thus permitting the mating housing to travel over the frustoconical section and the flange(s) until the housing abuts against an object to be secured. At this point, the canted coil spring expands to the constraint of the pin groove and restrains the mating housing to the pin.

The fastener in accordance with aspects of the present invention may be used to fasten, hold, or position two or more objects together. In one embodiment, an object to be held may be secured between two end plates by the fastener device, for example such as a gasket held between two flanges or a body tissue or bone segment held between two medically acceptable plates. Alternatively, the two end plates may be secured to one another without an object in between. For example, one end plate could be a lid and another end plate could be a rim or flange of a container for securing the lid to the container.

The canted coil spring and the housing groove of the mating housing are selected such that when the canted coil spring is engaged in the pin groove, an axial force is generated by the canted coil spring on one of the flanges in a distal direction, towards the frustoconical section. Because the object to be held is constrained between the two end plates, the pin head, and the housing contact surface, the axial force exerts a corresponding compressive force on the object, referred to herein as a pre-load force. The characteristics of the canted coil spring and the groove configuration of the housing groove may be selected to provide a predetermined pre-load force on the object, albeit within a predictive and/or tailored range.

A removal tool may be used to disengage the mating housing from the pin. The removal tool is preferably a hollow cylindrical device comprising a push end configured for compressing the canted coil spring to disengage the same from the pin groove, for example, to remove the object from between the two end plates. The removal tool is preferably made from a metallic material (such as stainless steel) having a wall thickness of sufficient size to project between the pin and the opening on the mating housing to compress the canted coil spring. To ensure that the canted coil spring is removable from the groove, the axis of the coil width, referred to herein as the major axis, is positioned above (or outside) the outer perimeter of the flanges, or of the frustoconical section if the canted coil spring is seated in a groove adjacent thereto. This allows the push end of the removal tool to contact a portion of the spring that deflects when exerted by a force. At this point, the mating housing may be retracted away from the pin to free the pin from its constraint with the mating housing.

According to a second broad aspect of the present invention, a fastener device may be provided that includes a mating housing formed from two or more housing parts that are separately formed and subsequently welded together, machined from a billet of metal, or molded from a polymer plastic. A pair of axial slots are formed in the mating housing for receiving a pair of keys. The pair of keys are configured to traverse along the two axial slots to delimit movement of the canted coil spring. In one exemplary embodiment, a pin may be incorporated on each key to provide visual indicia of the position of the two keys.

In use, an object to be held is placed in between the two end plates and the pin is inserted through aligned bores provided within the endplates, the bores each dimensioned to receive the pin therethrough. The mating housing is then inserted over the frustoconical section of the pin and moved proximally until the housing contact surface abuts one of the end plates. The two keys are then moved into a locked position so that their sloped surfaces rest against the spring to delimit movement of the spring within the housing groove. As the spring is an axial canted coil spring, a spring force is exerted against the groove side wall and the flange adjacent the pin groove in which the spring is positioned. This in turn provides a pre-load force on the object.

To release the object from the fastener device, the two keys are moved to an unlocked position to permit movement of spring within the housing groove. The mating housing can now be moved distally, which causes the spring to expand radially outward when it travels over a flange, until the mating housing separates from the pin.

According to a third broad aspect of the present invention, a fastener device may be provided having a mating housing further comprising a housing groove having a spring positioned therein. In one exemplary embodiment, one of the side walls of the groove comprises a slope dimensioned and configured to turn the axis of the spring defined by the coil height or coil width to about 45 degrees of its normal position. The spring incorporated herein may be an axial canted coil spring or a radial canted coil spring. The spring turn angle in combination with the sloped recessed sections of the pin fixedly secures the mating housing to the pin without the possibility of compressing the canted coil spring to release the same from the pin groove.

According to a fourth broad aspect of the present invention, a fastener device may be provided having a mating housing incorporating a housing groove for receiving a canted coil spring, and a cylindrical overhang or shroud defining a proximally facing cavity. Two cylindrical bosses are formed into the groove end wall for receiving two helical springs, one in each boss. The two helical springs are aligned such that their axes are parallel to the axis of the pin, and are configured to exert an axial force on a removal tool to bias the removal tool proximally away from the groove end wall. After the removal tool is used to compress the canted coil spring to remove the mating housing from the pin, the two helical springs return the tool to its ready position. In an alternative embodiment, a garter-type canted spring may be used instead of the two helical springs to bias the removal tool in the proximal direction.

According to a fifth broad aspect of the present invention, a fastener device may be provided having a mating housing incorporating a first housing section threadedly engaged to a second housing section and forming a housing groove therebetween. More specifically, a first housing section is provided with an end wall having a cylindrical cylinder that functions as a threaded collar for threaded engagement with a sloped second housing section having external threads for threaded engagement with the internal threads on the threaded collar. The second housing section comprises a lip section and a sloped cone section for forming a sloped housing grove, which serves to rotate the angle of the canted coil spring to then impart both a radial force and an axial force.

To remove the pin from the housing once inserted as described with previous aspects above, the second housing section is configured to be rotated relative to the first housing section to move the second housing section distally to thereby enlarge the housing groove. Thus, the housing groove is variable and is configured to expand to provide sufficient circumferential clearance for the canted coil spring to expand into as the housing groove is expanded distally (i.e. towards the frustoconical section). Thus, the canted coil spring is able to move over the flanges, and the pin is removed from the object and end plates.

According to a sixth broad aspect of the present invention, a fastener device may be provided having a mating housing incorporating a variable housing groove for retaining a canted coil spring in either an active position or an inactive position. The mating housing comprises a first housing part, which comprises two coaxial cylinders connected to one another by an end plate. The two cylinders define an annular space therebetween for receiving two or more spaced apart compression springs. A ring comprising a sloped edge is positioned in the annular space adjacent the plurality of compression springs, which normally bias the ring distally towards an end plate. The ring further comprises a pair of bosses for receiving a pair of pins, which project in a radially outward direction relative to the housing centerline or the axis defined by the pin. The two pins are configured to slide or traverse along two axially oriented channels located on the outer cylinder of the first housing part.

An outer activation ring is coaxially disposed over the first housing part and is rotatable relative to the first housing part. In one exemplary embodiment, the outer activation ring incorporates a pair of slots for receiving the two pins. The two opposing surfaces of the slots function as cam surfaces for moving the two pins from a proximal most position to a distal most position to expand the housing groove. Movement of the two pins correspondingly move the ring comprising the wedge surface, which in turn enlarges or reduces the housing groove depending on the pin position.

To remove the pin from the mating housing, the activation ring is rotated to move the two pins from a proximal most position to a distal most position to retract the wedge ring within the annular groove. Doing so will allow the canted coil spring to deflect and expand when moving the canted coil spring distally and over the flange. Once the mating housing is fully separated from the pin, the pin can slide out of the aligned bores of the two end plates and the object may be removed from in between end plates.

### BRIEF DESCRIPTION OF THE DRAWINGS

FIGS. 1-5 are cross-sectional views of a representative fastener provided in accordance with aspects of the present invention in various stages of engagement and disengagement between a pin and a mating housing.

FIG. 6 is a cross-sectional side view of an alternative embodiment provided in accordance with aspects of the present invention, which shows a pin with a plurality of sloped pin grooves.

FIGS. 7-10 are cross-sectional views of a representative fastener provided in accordance with yet other aspects of the present invention in various stages of engagement and disengagement between a pin and a mating housing.

FIGS. 11-13 are cross-sectional views of yet another fastener embodiment provided in accordance with aspects of the present invention in various stages of assembly between a pin and a mating house.

FIG. 14 is a cross-sectional side view of an alternative embodiment provided in accordance with aspects of the present invention.

FIGS. 15-18 are cross-sectional views of still yet another fastener embodiment provided in accordance with aspects of the present invention in various stages of engagement and disengagement between a pin and a mating house.

FIGS. 19-23 are cross-sectional views of still yet another fastener embodiment provided in accordance with aspects of the present invention in various stages of engagement and disengagement between a pin and a mating house.

FIGS. 24-30 are cross-sectional views of yet another fastener embodiment provided in accordance with aspects of the present invention in various stages of engagement and disengagement between a pin and a mating house.

### DETAILED DESCRIPTION OF THE PREFERRED EMBODIMENTS

The detailed description set forth below in connection with the appended drawings is intended as a description of the presently preferred embodiments of fasteners for latching and locking two or more objects together at a variable distance apart. The fasteners are provided in accordance with aspects of the present invention and is not intended to represent the only forms in which the present invention may be constructed or utilized. The description sets forth the features and the steps for constructing and using the fasteners of the present invention in connection with the illustrated embodiments. It is to be understood that the same or equivalent functions and structures may be accomplished by different embodiments and are also intended to be encompassed within the spirit and scope of the present invention, especially those incorporating a combination of features shown in the different embodiments included herein. As denoted elsewhere herein, like element numbers are intended to indicate like or similar elements or features.

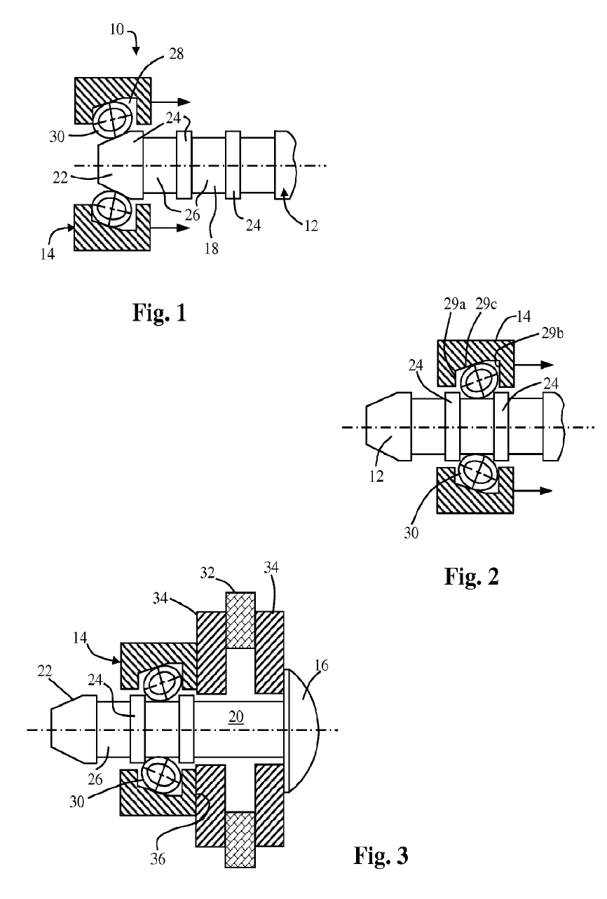

FIGS. 1-5 illustrate a cross-sectional view of one example of a fastener device 10 provided according to one embodiment of the present invention. In this first embodiment, the fastener device 10 comprises a pin 12 and a corresponding mating housing 14. The pin 12 includes a pin head 16 (FIG. 3), a first shank section 18 on a distal end of the pin 12 furthest from the pin head 16, and a second shank section 20, which is located on the proximal end of the pin 12 between the pin head 16 and the first shank section 18. In one exemplary embodiment, the first shank section 18 is generally serrated and includes a frustoconical tip 22 for facilitating insertion into the mating housing 14. The serration is formed by two or more spaced apart flanges or threads 24 on the first shank section 18, which define a plurality of grooves 26 for mating engagement with the mating housing 14, as further discussed below. The first flange 24 is preferably integrated with the frustoconical section. The mating housing 14 may engage with any one of the plurality of grooves 26 to thus provide for a degree of freedom or flexibility when using the fastener 10 to couple two or more objects together of different sizes. Alternatively, the pin 12 may be sized and dimensioned for a specific application and therefore incorporates a single groove 26.

In one exemplary embodiment, the mating housing 14 comprises a housing groove 28 for accommodating a canted coil spring 30. As is readily apparent to a person of ordinary skill in the art, the mating housing 14 is generally cylindrical in shape and has a hollow cavity resembling a nut. In the cross-sectional view shown, the housing groove 28 comprises two side walls 29a, 29b that are generally orthogonal to the longitudinal axis of the pin 12 and a back wall 29c. Although the back wall 29c is shown comprising a slope, the back wall 29c may be generally parallel to the longitudinal axis of the pin 12 and one or both side walls 29a, 29b may be sloped relative to the longitudinal axis. As disclosed in U.S. Pat. Nos. 4,961,253; 4,826,144; 4,804,290; 5,545,842; 5,411,348; 4,678,210; 5,139,276; 5,108,078; 5,082,390; and 5,239,737, the contents of each of which are expressly incorporated herein by reference, the characteristics of canted coil spring 30 may be manipulated by the geometry of the housing groove 28. Thus, in accordance with aspects of the present invention, the mating housing 14 may incorporate grooves of different geometries to vary the radial, axial, or both radial and axial forces exerted by the canted coil spring 30 when holding two objects together.

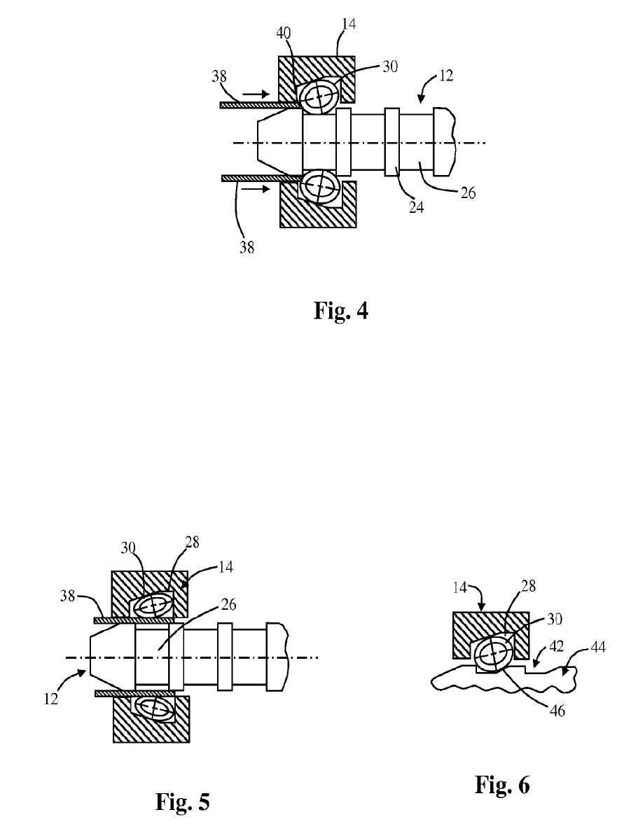

In one exemplary embodiment, the canted coil spring 30 is more explicitly described as a radial canted coil spring and comprises a coil height axis and a coil width axis, also shown and defined in FIG. 4. The canted coil spring 30 comprises a plurality of coils and is a garter-type-spring with two single coils shown, one above and one below the pin 12. The plurality of coils are canted along a same direction relative to a plane normal to a centerline of the spring axis. To couple the mating housing 14 to the pin, the mating housing 14 is pushed over the frustoconical section 22 of the pin 12 to deflect or compress the canted coil spring 30 along the coils' height axes, thus permitting the mating housing 14 to travel over the frustoconical section 22 and the flange(s) 24 until the housing 14 abuts against an object to be secured, as further discussed below with reference to FIG. 3. At this point, the canted coil spring 30 expands to the constraint of the pin groove 26 and restrains the mating housing 14 to the pin 12 (FIGS. 1B and 1C).

With reference now to FIG. 3, the fastener 10 in accordance with aspects of the present invention may be used to fasten, hold, or position two or more objects together. In the embodiment shown, an object 32 to be held may be secured between two end plates 34 by the fastener device 10, for example such as a gasket held between two flanges or a body tissue or bone segment held between two medically acceptable plates. Alternatively, the two end plates 34 may be secured to one another without an object in between. For example, one end plate could be a lid and another end plate could be a rim or flange of a container for securing the lid to the container.

In one exemplary embodiment, the canted coil spring 30 and the housing groove 28 of the mating housing 14 are selected such that when the canted coil spring 30 is engaged in the pin groove 16, an axial force is generated by the canted coil spring 30 on one of the flanges 24 in a distal direction, towards the frustoconical section 22. Because the object 32 to be held is constrained between the two end plates 34, the pin head 16, and the housing contact surface 36, the axial force exerts a corresponding compressive force on the object 32, referred to herein as a pre-load force. As disclosed in the patents referenced above, the canted coil spring 30 characteristics and the groove configuration of the housing groove 28 may be selected to provide a predetermined pre-load force on the object 32, albeit within a predictive and/or tailored range.

Although shown and described herein throughout as distinct articles, specific embodiments of the fastener device may include a mating housing including a housing contact surface 36 that is attached to or integrally formed with one of the end plates 34. This feature is contemplated in connection with the present embodiment as well as all aspects and embodiments of the fastener device described below.

Referring now to FIG. 4, in one exemplary embodiment, a removal tool 38 may be used to disengage the mating housing 14 from the pin 12. The removal tool 38 is preferably a hollow cylindrical device comprising a push end 40 configured for compressing the canted coil spring 30 to disengage the same from the pin groove 26 (FIG. 3), for example, to remove the object 32 from between the two end plates 34. The removal tool 38 is preferably made from a metallic material (such as stainless steel) having a wall thickness of sufficient size to project between the pin 12 and the opening on the mating housing 14 to compress the canted coil spring 30. To ensure that the canted coil spring 30 is removable from the groove 26, the axis of the coil width, referred to herein from time to time as the major axis, is positioned above (or outside) the outer perimeter of the flanges 24, or of the frustoconical section 22 if the canted coil spring 30 is seated in a groove adjacent thereto. This allows the push end 40 of the removal tool 38 to contact a portion of the spring 30 that deflects when exerted by a force.

FIG. 5 is a cross-sectional side view of the fastener device 10 of FIG. 4 with the removal tool 38 inserted to fully disengage the spring 30 from the groove 26. At this point, the mating housing 14 may be retracted away from the pin 12 to free the pin 12 from its constraint with the mating housing 14.

FIG. 6 is a cross-sectional side view of one example of an alternative fastener device 42 provided in accordance with aspects of the present invention. The fastener device 42 comprises a mating housing 14 comprising a housing groove 28 for accommodating a canted coil spring 30 and a pin 44. However, rather than incorporating a uniform nominal pin diameter, the alternative pin 44 incorporates a plurality of sloped recessed sections 46 in between two adjacent flanges. The sloped recessed sections 46 facilitate advancement of the mating housing 14 over the pin to engage the two during use.

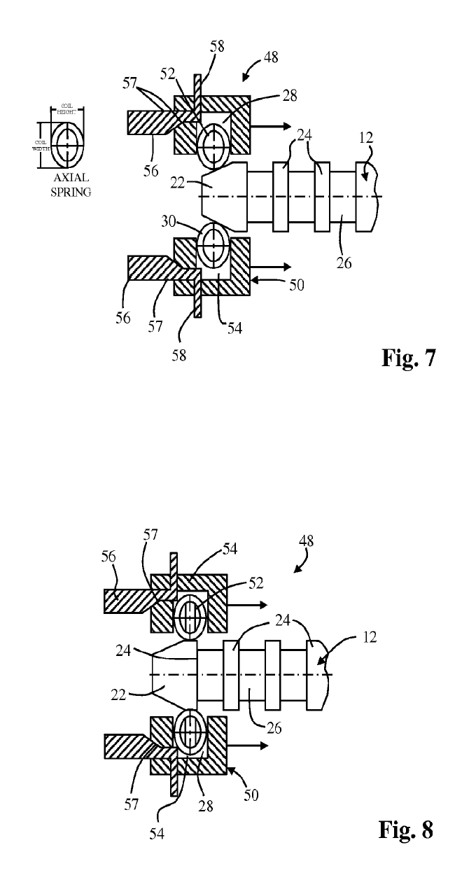

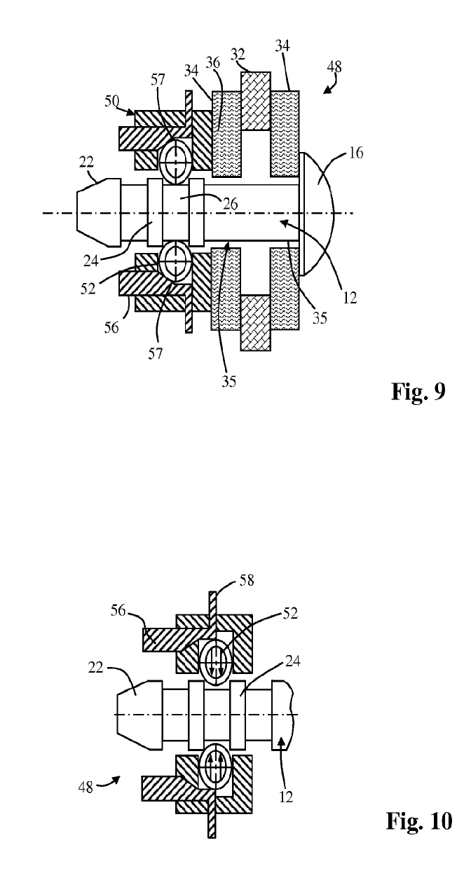

FIGS. 7-10 are cross-sectional side views of one example of yet another fastener device 48 provided in accordance with aspects of the present invention. In one exemplary embodiment shown in FIG. 7, the fastener device 48 comprises a pin 12 and a mating housing 50 comprising a spring 52 (formed of a plurality of spring coils) disposed therein. The spring 52 is preferably an axial canted spring in that the spring coils are axially compressible relative to the axis of the spring ring. The mating housing 50 comprises a housing groove 28, which in the embodiment shown has a square configuration. The mating housing 50 may be made from two or more housing parts that are separately formed and subsequently welded together, machined from a billet of metal, or molded from a polymer plastic. A pair of axial slots 54 are formed in the mating housing 50 for receiving a pair of keys 56. The pair of keys 56 are configured to traverse along the two axial slots 54 to delimit movement of the spring 52, as further discussed below. In one exemplary embodiment, a pin 58 may be incorporated on each key to provide visual indicia of the position of the two keys 56. For example, when the two keys 56 are moved in the proximal direction towards the pin head (FIG. 9), the position provides a visual feedback indicating that the spring 52 is now locked in position.

In practice, the two keys 56 may be part of a cylinder, plate, or cam mechanism for cooperating with the outside of the mating housing 50 to move in between a locked and an unlocked position. For example, means may be incorporated that can be rotated clockwise to advance the keys 56 to a locked position and rotated counter-clockwise to unlock the keys. Alternatively, means may be incorporated that can be pushed to move the keys to a locked position and pulled to unlock the keys. Preferably, the means engages the mating housing 50 to secure the keys 56 in the locked position until it is desired to unlock the keys. The two keys 56 each comprise a sloped surface 57 for facilitating movement of the keys over the spring 52 in the locked position (FIG. 9).

FIG. 8 shows the two keys 56 retracted distally away from the spring 52 and available space 54 above the spring within the housing groove 28 to accommodate the spring as it expands when moving across the flange 24.

FIG. 9 shows the fastener device 48 provided in accordance with aspects of the present invention securing an object 32 to be held in between two end plates 34. With reference to FIGS. 8 and 9, this may be accomplished by first placing the object 32 in between the two end plates 34 and inserting the pin 12 through aligned bores 35 provided within the endplates 34, the bores 35 each dimensioned to receive the pin 12 therethrough. The mating housing 50 is then inserted over the frustoconical section 22 of the pin 12 and moved proximally until the housing contact surface 36 abuts one of the end plates 34. The two keys 56 are then moved into a locked position so that their sloped surfaces 57 rest against the spring 52 to delimit movement of the spring within the housing groove 28. As the spring 52 is an axial canted coil spring, a spring force is exerted against the groove side wall and the flange 24 adjacent the pin groove 26 in which the spring is positioned. This in turn provides a pre-load force on the object 32 to be held.

To release the object 32 from the fastener device 48, the two keys 56 are moved to an unlocked position (i.e., moved distally) to permit movement of spring 52 within the housing groove 28. The mating housing 50 can now be moved distally, which causes the spring to expand radially outward when it travels over a flange, until the mating housing 50 separates from the pin 12.

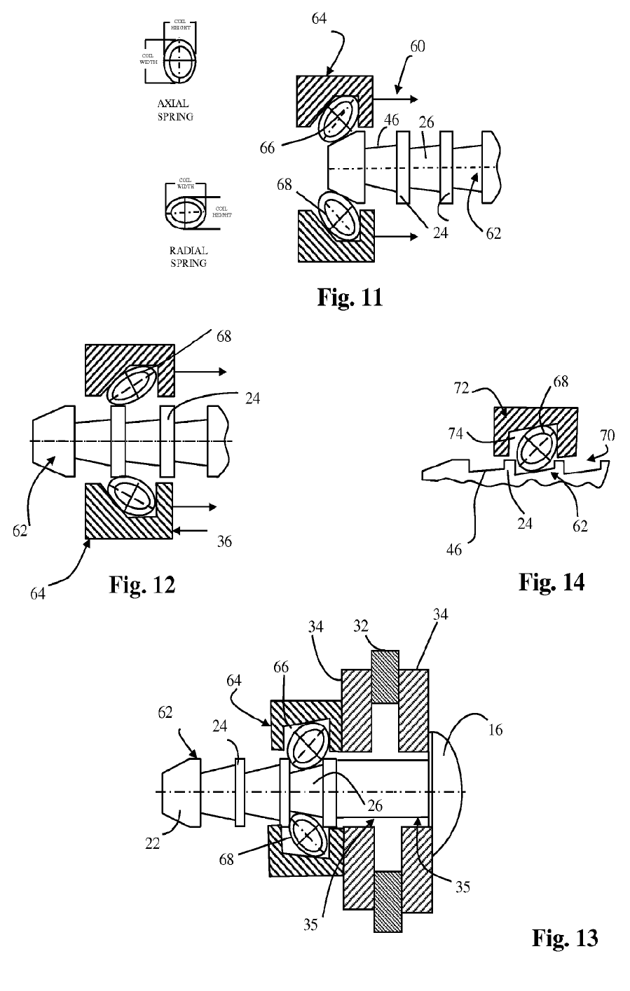

FIGS. 11-14 provide an example of a fastener device 60 provided in accordance with yet another aspect of the present invention. Fastener device 60 comprises a pin 62 and a mating housing 64, the mating housing 64 further comprising a housing groove 66 having a spring 68 positioned therein. In one exemplary embodiment, one of the side walls of the groove comprises a slope dimensioned and configured to turn the axis of the spring defined by the coil height or coil width to about 45 degrees of its normal position. The spring 68 incorporated herein may be an axial canted coil spring or a radial canted coil spring. As further discussed below with reference to FIG. 13, the spring turn angle in combination with the sloped recessed sections 46 of the pin 62 fixedly secures the mating housing 64 to the pin 62 without the possibility of compressing the canted coil spring 68 to release the same from the pin groove.

As shown, the pin 62 incorporates a plurality of sloped recessed sections 46 in between adjoining flanges 24. When cooperating with the housing groove 66, the sloped recessed sections 46 of the pin 62 and the housing groove 66, and more particularly the sloped housing groove, ensure both an axial force component for pre-loading and a locking position so that the spring cannot be compressed to disengage from the pin groove 26.

FIG. 12 shows the spring 68 being compressed as it travels over the flange 24. Although not shown, the spring 68 returns to its more relaxed or decompressed state when it travels past the flange and into a pin groove 24 and again is compressed when it travels over the second flange 24 and so forth.

FIG. 13 shows the fastener device 60 provided in accordance with aspects of the present invention securing an object 32 to be held in between two end plates 34. With reference to FIG. 12 and FIG. 13, this may be accomplished by first placing the object to be held 32 in between the two end plates 34 and inserting the pin 62 through aligned bores 35 formed within each end plate 34, the bores 35 each dimensioned to allow passage of the pin 62 therethrough. The mating housing 64 is then inserted over the frustoconical section 22 of the pin 62 and moved proximally until the housing contact surface 36 abuts one of the end plates 34. At this point, the fastener device 60 is sized so that the canted coil spring 68 expands within one of the grooves 26 and against one of the flanges 24. Because the canted coil spring 68 is in contact with two sloped surfaces, one on the mating housing 64 and one on the pin 62, an axial force is exerted on the pin to create a pre-load on the object 32.

Unlike the fastener device 10 of FIGS. 1-4, the spring 68 cannot be compressed to disengage from the groove 26 using a similar removal device. As shown, the axes defined by the longer widths of the two individual coils are positioned below (or inside) the outer perimeter of the flange 24. Hence, a removal tool (such as the one shown in FIG. 4) cannot be used to lift the spring 68 above the flange 24 to disengage the spring same from the groove 26. Thus, unless a removal force that is sufficient to destroy the spring 68 is applied to the mating housing 64 to disengage the housing from the pin 62, the fastener 60 is of a permanent type that cannot be disengaged once the mating housing 64 is engaged to the pin 62.

FIG. 14 shows an example of another alternative fastener device 70 provided in accordance with aspects of the present invention which comprises a mating housing 72 comprising a groove 74 and a pin 62. In one exemplary embodiment, the groove 74 incorporates two side walls, both of which are normal to the axis of the pin 62, and a sloped back wall, which slopes relative to the axis of the pin 62. Like the fastener device 60 of FIG. 13, the sloped back wall and the sloped recessed section of the pin 62 orients the axis defined by the longer width of the spring below the flange 24. Thus, the canted coil spring 68 becomes permanently secured to the groove 26 and cannot be lifted to disengage the mating housing 72 from the pin 62.

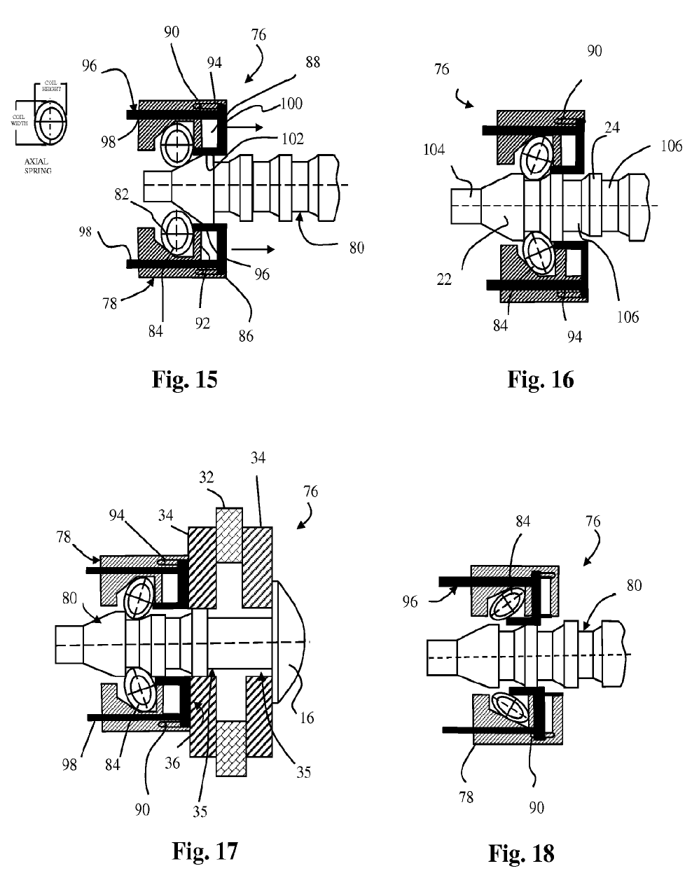

FIGS. 15-18 are cross-sectional side views of an example of an alternative fastener device 76 provided in accordance with yet another embodiment of present invention. As shown in FIG. 15, fastener device 76 comprises a mating housing 78 engageable with a pin 80. In the embodiment shown, the mating housing 78 incorporates a housing groove 82 for receiving a spring 84, which is preferably an axial canted coil spring, and a cylindrical overhang or shroud 86 defining a proximally facing cavity 88. In the embodiment shown, two cylindrical bosses 90 are formed into the groove end wall 92 for receiving two helical springs 94, one in each boss. In the example shown, the two helical springs 94 are aligned such that their axes are parallel to the axis of the pin 80, and are configured to exert an axial force on a removal tool 96 to bias the removal tool proximally away from the groove end wall 92. As further discussed below, after the removal tool is used to compress the canted coil spring 84 to remove the mating housing 78 from the pin, the two helical springs 94 return the tool to its ready position, shown in FIG. 15. In an alternative embodiment, a garter-type canted spring may be used instead of the two helical springs 94 to bias the removal tool in the proximal direction.

In one exemplary embodiment, the removal tool 96 comprises a generally cylindrical end plate 100 and a cylindrical cylinder 102 having a diameter or opening sufficiently large to receive the pin 80. A pair of retaining arms 98 extend distally from the end plate 100 and slightly inwardly from the outer perimeter of the end plate to create an overhang section 86, which is configured to be biased by the two helical springs 94. The two retaining arms 98 pass through a pair of slots formed in the mating housing 78 and are retained to the housing by detents or other known means in the prior art for preventing the removal tool 96 from being displaced from the mating housing 78.

A blunt nose section 104 is incorporated at the distal tip of the pin 80, distal of the frustoconical section 22. The pin further comprises a plurality of grooves 106 comprising both a constant diameter section and a sloped section and a plurality of flanges 24. As shown in FIGS. 16 and 17, the sloped section of the groove 106 and the sloped section of the back wall of the housing groove 82 cooperate to rotate the axial canted spring 84 so that the axis defined by the longest width dimension, or the axis defined by the short height dimension, is rotated relative to the axis defined by the pin 80. Consequently, the axial canted spring 84 is induced by the combination housing groove 82 and pin groove 106 to provide both a radial force component and an axial force component, which in turn produce a pre-load force on an object 32 to be held between end plates 34 (FIG. 17).

Referring now to FIG. 17, the fastener device 76 is provided in accordance with aspects of the present invention securing an object 32 to be held in between two end plates 34. With reference to FIG. 12 and FIG. 13, this may be accomplished by first placing the object 32 in between the two end plates 34 and inserting the pin 80 through aligned bores 35 formed within each end plate 34, the bores 35 each dimensioned to allow passage of the pin 80 therethrough. The mating housing 78 is then inserted over the frustoconical section 22 of the pin 80 and moved proximally until the housing contact surface 36 abuts one of the end plates 34. At this point, the fastener device 76 is sized so that the canted coil spring 84 expands within one of the grooves 106 and against one of the flanges 24. Because the canted coil spring 80 is in contact with two sloped surfaces, one on the mating housing 78 and one on the pin 80, an axial force is exerted on the pin 80 to create a pre-load on the object 32.

To remove the object 32 from between the end plates 34, a distally directed force is applied to move the removal tool 96 distally, i.e., to the left in FIGS. 17 and 18. The force must be sufficient to overcome the force provided by the two helical springs 94 and the canted coil spring 84 to lift the canted coil spring 84 from the pin groove 106. The mating housing 78 can now be retracted away from the pin 80 until it completely separates from the pin. At this time, the pin can be removed from the aligned bores 35 of the two end plates 34 and the object 32, and thus the object 32 may be removed from between the end plates 34.

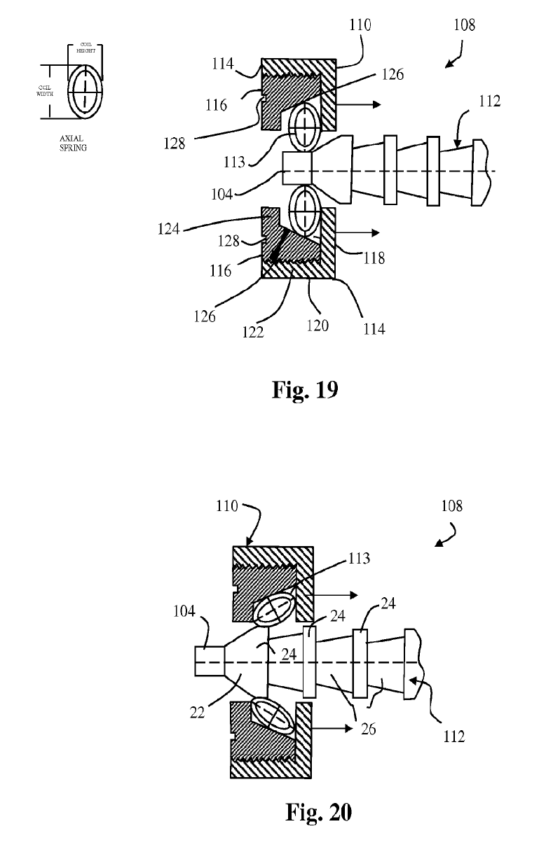

FIGS. 19-23 illustrate an example of a fastener device 108 provided in accordance with yet another embodiment of the present invention. The fastener device 108 comprises a mating housing 110 adapted to matingly engage a pin 112 for fastening two or more objects together. In a specific aspect of the present invention, the mating housing 110 incorporates a first housing section 114 threadedly engaged to a second housing section 116 and forming a housing groove 118 therebetween. More specifically, a first housing section 114 is provided with an end wall 120 having a cylindrical cylinder 122 that functions as a threaded collar for threaded engagement with a sloped second housing section 116 having external threads for threaded engagement with the internal threads on the threaded collar 122. The second housing section 116 comprises a lip section 124 and a sloped cone section 126 for forming a sloped housing grove 118, which serves to rotate the angle of the canted coil spring 113 to then impart both a radial force and an axial force, as further discussed below.

To rotate the second housing section 116 relative to the first housing section 114, a pair of turning notches 128 is incorporated on the second housing piece 116. A two-prong turning tool (not shown) may be used to engage the two turning notches 128 to then rotate the second housing section 116 relative to the first housing section 114. Alternatively, two projections, a projection and a notch, a lever or other similar means may be used to rotate the second housing 116 without deviating from the spirit and scope of the present invention.

FIG. 5B shows the mating housing 110 provided in accordance with aspects of the present invention advanced partially over the pin 112. As the canted coil spring 113 moves over the frustoconical section 22 and the flange 24, it is simultaneously rotated and compressed to fit within the constraint of the space or gap defined by the housing groove 118 and the particular section of the pin 112.

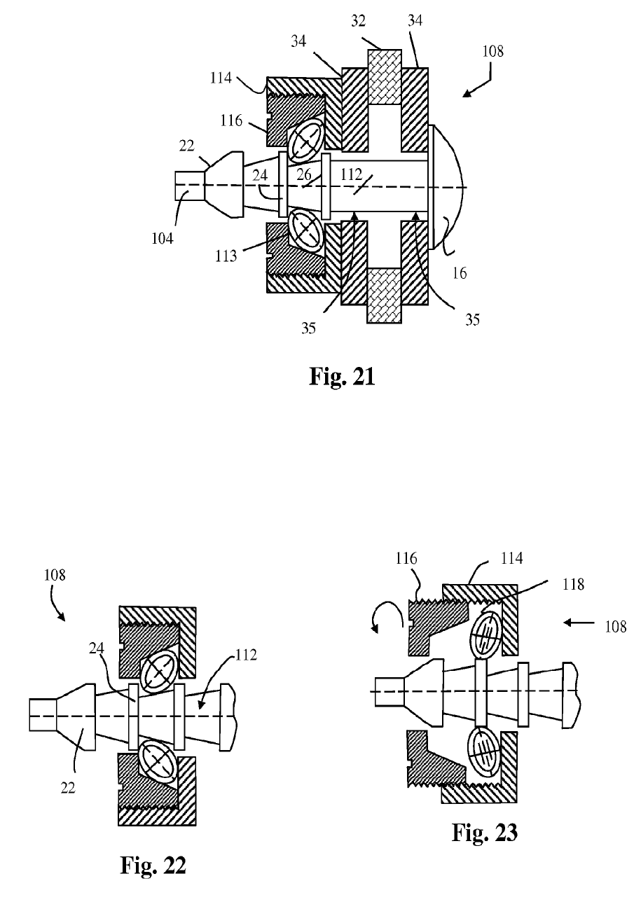

FIG. 21 shows the fastener 108 provided in accordance with aspects of the present invention securing an object 32 to be held in between two end plates 34. With reference to FIG. 20 in addition to FIG. 21, this may be accomplished by first placing the object 32 in between the two end plates 34 and inserting the pin 112 through aligned bores 35 formed within each end plate 34, the bores 35 each dimensioned to allow passage of the pin 112 therethrough. The mating housing 110 is then inserted over the blunt section 104 and then over the frustoconical section 22 of the pin 112, which deflects the canted coil spring 113 along the minor axis (i.e. the axis having the smaller width dimension). When the canted coil spring 113 moves over a groove 26 (e.g. the distal-most groove 26 or any subsequent groove 26 located proximally thereof depending on the length of the pin 112 and the number of grooves 26 incorporated) the spring 113 expands to the constraint provided by the housing groove 118 and the pin groove 26. At this point and because the canted coil spring 113 is in contact with two sloped surfaces, one on the mating housing 110 and one on the pin 112, an axial force is exerted on the pin to create a pre-load on the object 32.

FIG. 22 is a cross-section side view of the fastener device 108 shown in FIG. 19 in an engaged position, similar to FIG. 21, but without the two end plates 34 and object 32 held therebetween for clarity. In this instance, a removal tool (not shown) could not be used to collapse or compress the canted coil spring 113 to lift the spring above the flange 24 from the direction of the frustoconical section 22 of the pin 112. As previously discussed, this is because the axis defined by the largest coil diameter (i.e. the major axis) is positioned below (or inside) the outermost circumferential edge of the flange 24. Thus, in accordance with aspects of the present invention, the second housing section 116 is configured to be rotated relative to the first housing section 114 to move the second housing section 116 distally to thereby enlarge the housing groove 118. Thus, the housing groove 118 is variable and is configured to expand to provide sufficient circumferential clearance for the canted coil spring 113 to expand into as the housing groove 118 is expanded distally (i.e. towards the frustoconical section 22). Thus, the canted coil spring 113 is able to move over the flanges 24 (FIG. 23), and the pin 112 is removed from the object 32 and end plates 34.

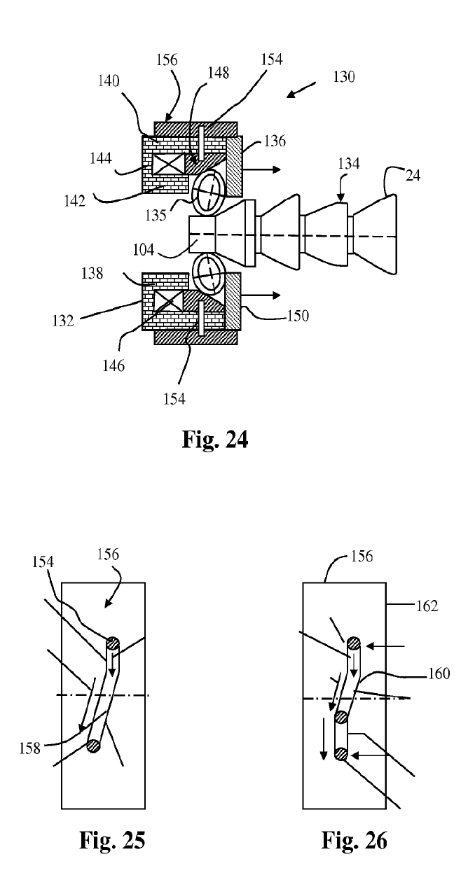

FIGS. 24-30 illustrate an example of yet another fastener device 130 provided in accordance with aspects of the present invention. In this embodiment, the fastener device 130 comprises a mating housing 132 engageable with a pin 134 for fastening or holding two or more objects together. In accordance with one aspect of the present invention, the mating housing 132 incorporates a variable housing groove 136 for retaining a spring 135, which is preferable an axial canted coil spring, in either an active position (FIG. 24) or an inactive position (FIG. 30). The mating housing 132 comprises a first housing part 138, which comprises two coaxial cylinders 140, 142 connected to one another by an end plate 144. The two cylinders 140, 142 define an annular space 146 therebetween for receiving two or more spaced apart compression springs (not shown). The two or more compression springs may be spaced from one another by arcuate spacers (not shown) or alternatively a garter-type axial canted coil spring may be used.

A ring 148 comprising a sloped edge is positioned in the annular space 146 adjacent the plurality of compression springs, which normally bias the ring 148 distally towards an end plate 150. In one exemplary embodiment, the end plate 150 can be attached to the first housing part 138 by welding, mechanical fastening, interference locking, or adhesive bonding to retain the canted coil spring 135 within the housing. The ring 148 further comprises a pair of bosses for receiving a pair of pins 154, which project in a radially outward direction relative to the housing centerline or the axis defined by the pin 154. The two pins 154 are configured to slide or traverse along two axially oriented channels (not shown) located on the outer cylinder 140 of the first housing part 138.

An outer activation ring 156 is coaxially disposed over the first housing part 138 and is rotatable relative to the first housing part. A top view of the outer activation ring 156 is shown in FIG. 25, shown without the end plate 144 of the first housing part 138. In one exemplary embodiment, the outer activation ring 156 incorporates a pair of slots 158 for receiving the two pins 154. The two opposing surfaces of the slots 158 function as cam surfaces for moving the two pins 154 from a proximal most position (FIG. 24) to a distal most position (FIG. 30) to expand the housing groove 136. Movement of the two pins 154 correspondingly move the ring 148 comprising the wedge surface, which in turn enlarges or reduces the housing groove 136 depending on the pin position.

The slot 158 shown in FIG. 25 comprises a first slot section at an angle with a second slot section. This slot configuration allows the two pins 154 to be moved automatically from the distal most position where the housing groove 136 is enlarged to the proximal most position (FIG. 26) where the housing groove 136 is reduced. Movement of the pins 154 are facilitated by the compression springs pushing the pins in the proximal direction, which if occurs will cause the outer activation ring 156 to rotate clockwise when viewed from a distal position on the in towards a proximal position.

FIG. 26 shows the outer activation ring 156 with an alternative slot 160. The alternative slot 160 incorporates two end slot sections that are generally parallel to the end edge 162 of the ring 156 and sloped section relative to the end edge. In the two extreme pin positions, i.e., distal most and proximal most positions, the two end slot sections of the alternative slot 160 are flat and therefore exert an equal but opposite force as the force generated by the two compression springs on the two pins 154. Hence, the pins 154 do not automatically return from a distal most position to a proximal most position without first manually rotating the activation ring 156.

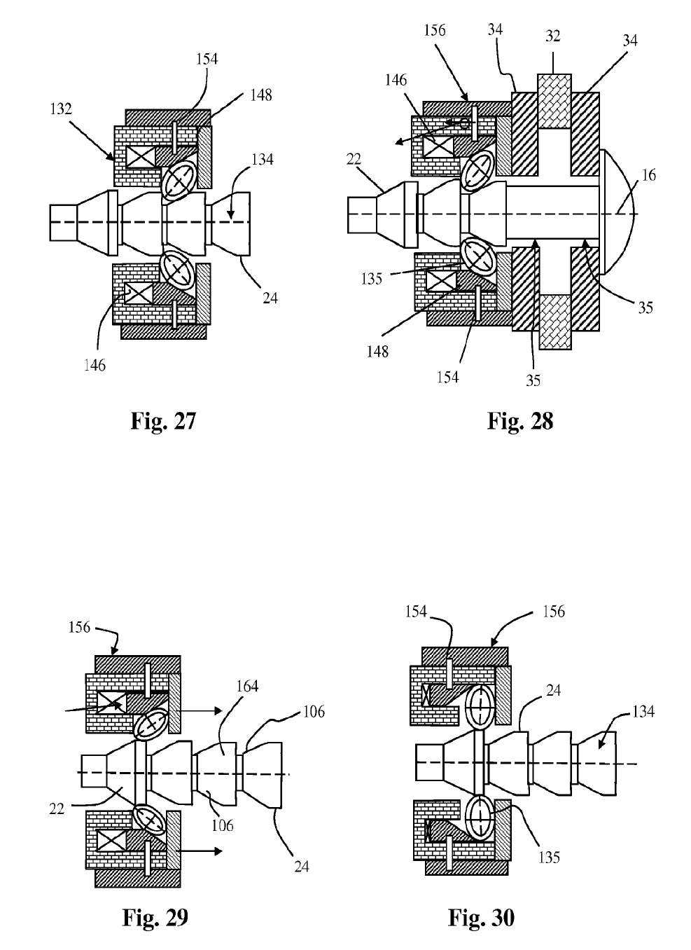

Referring again to FIG. 24 in combination with FIG. 27, the pin 134 is shown with a blunt nose section 104, a frustoconical section 22, and a plurality of sloped recessed sections 164 that define pin grooves 106. As previously discussed, when the mating housing 132 is engaged over the pin 134, the spring 135 deflects as it travels over the frustoconical section 22 and the sloped recessed sections 164 and expands when moved into the pin groove sections 106.

FIG. 28 shows the fastener device 130 provided in accordance with aspects of the present invention securing an object 32 to be held in between two end plates 34. This may be accomplished by first placing the object 32 in between the two end plates 34 and inserting the pin 134 through aligned bores 35 formed within each end plate 34, the bores 35 each dimensioned to allow passage of the pin 134 therethrough. The mating housing 132 is then inserted over the blunt section 104 and then over the frustoconical section 22 of the pin 134, which deflects the canted coil spring 135 along the axis having the smaller width dimension (i.e. the minor axis). When the canted coil spring 135 moves over a pin groove 106, which could be a distal most groove or any subsequent groove located proximally thereof depending on the length of the pin and the number of pin grooves incorporated, the canted coil spring 135 expands to the constraint provided by the housing grove 136 and the pin groove 106. At this point and because the canted coil spring 135 is in contact with two sloped surfaces, one on the mating housing 132 and one on the pin 134, an axial force is exerted on the pin 134 to create a pre-load on the object 32 held in between end plates 34.

FIG. 29 is a cross-sectional side view of the fastener device 130 shown in FIG. 24 in an engaged position, similar to FIG. 28, but without the two end plates 34 and object 32 to be held therebetween for clarity. To retract the mating housing 132 from the position on the pin 134 shown in FIG. 29 to a position shown in FIG. 30, as previously discussed, the activation ring 156 is rotated to move the two pins 154 from a proximal most position to a distal most position to retract the wedge ring 148 within the annular groove 146 (FIGS. 25, 25 and 30). Doing so will allow the canted coil spring 134 to deflect and expand when moving the canted coil spring 134 distally and over the flange 24. Once the mating housing 132 is fully separated from the pin 134, the pin can slide out of the aligned bores 35 of the two end plates 34 and the object 32 may be removed from in between end plates 34.

Although limited preferred embodiments and methods for making and using fasteners provided in accordance with aspects of the present invention have been specifically described and illustrated, many modifications and variations will be apparent to those skilled in the art. For example, various material changes may be used, incorporating different mechanical engagement means to attach the various components to one another, making use of two or more different materials, making the pins longer or shorter, adding colors for aesthetic appeal, etc. Accordingly, it is to be understood that the fasteners constructed according to principles of this invention may be embodied in other than as specifically described herein. As further examples, different removal tools for lifting a canted spring and different devices for varying a mating housing groove, and aspects discussed specifically for one fastener embodiment may be used for other embodiments provided the components do not conflict or are compatible may all be practiced without deviating from the spirit and scope of the present invention. The invention is also defined in the following claims.

What is claimed is:

1. A system for fastening two or more objects together, comprising:
a pin comprising a proximal head configured to abut a first object and a shank section including an engagement portion comprising at least one pin groove, the shank section defining a longitudinal shaft having a shaft axis;
a mating housing comprising a bore, a housing groove, and an abutment surface configured to abut a second object;
a canted coil spring comprising a coil height defining a coil height axis and a coil width defining a coil width axis; and
a sloped surface associated with the housing groove for rotating the coil height axis to an orientation that is non-parallel and non-perpendicular to the shaft axis when the mating housing is engaged to the pin and the canted coil spring is positioned within the at least one pin groove.

2. The system of claim 1, wherein the abutment surface of the mating housing is at least one of attached to and integrally formed with the second object.

3. The system of claim 1, wherein the at least one pin groove comprises a sloped recessed section extending between a pair of adjacent flanges extending generally orthogonally from the shank section.

4. The system of claim 1, wherein the at least one pin groove comprises a recess of uniform diameter extending between a pair of adjacent flanges extending generally orthogonally from the shank section.

5. The system of claim 1, wherein the pin further includes a distal end comprising a frustoconical section.

6. The system of claim 1, wherein the mating housing is moveable toward the head of the pin but not away from the head of the pin by selectively engaging the canted coil spring with the at least one pin groove and orienting the coil width axis so that one of its ends is positioned radially closer to the shaft axis relative to the outer edge of a flange adjacent to the engaged pin groove.

7. The system of claim 1, further comprising a release tool configured to create smooth interference between the canted coil spring and the pin member such that the pin member may be disengaged from the canted coil spring and removed from the mating housing.

8. A fastener for fastening two or more objects together, comprising:
a pin comprising a shank section defining a longitudinal shaft having a shaft axis, the shank comprising a proximal head configured to abut a first object and an engagement portion comprising a pin groove;
a mating housing configured to receive the pin comprising a first housing section moveable relative to a second housing section and defining a variable housing groove, at least one of said first and second housing sections including an abutment surface configured to abut a second object; and
a canted coil spring positioned in the variable housing groove.

9. The fastener of claim 8, wherein the pin comprises two or more pin grooves and wherein the canted spring is positionable in any one of the two or more pin grooves.

10. The fastener of claim 8, wherein the pin groove comprises a sloped recessed section extending between a pair of adjacent flanges extending generally orthogonally from the shank section.

11. The fastener of claim 8, wherein the pin further includes a distal end comprising a frustoconical section.

12. The fastener of claim 8, wherein the mating housing is moveable toward the head of the pin but not away from the head of the pin by selectively engaging the canted coil spring with the variable pin groove and orienting the coil width axis so that one of its ends is positioned radially closer to the shaft axis relative to the outer edge of a flange adjacent to the engaged pin groove.

13. The fastener of claim 8, wherein the abutment surface of the mating housing is at least one of attached to and integrally formed with the second object.

14. A method for fastening at least two objects together, comprising:
providing a first object having a first bore extending therethrough;
providing a second object having a second bore extending therethrough, the second object positioned such that the second bore is in axial alignment with the first bore;
providing a mating housing comprising a bore, a housing groove, and a canted coil spring member positioned within the housing groove, the canted coil spring member comprising a coil height defining a coil height axis and a coil width defining a coil width axis;
inserting a pin member through the first and second bores, the pin member comprising a proximal head, a shaft member extending distally therefrom and defining a longitudinal shaft axis, a pin groove, and at least one flange positioned adjacent the pin groove with the at least one flange comprising an outer edge extending radially the shaft axis; and
advancing a mating housing proximally along the pin member by selectively engaging the canted coil spring member with the pin groove and orienting the coil width axis so that one of its ends is positioned radially closer to the shaft axis relative to the outer edge of the flange adjacent the engaged pin groove, such that said first and second objects are fastened together.

15. The method of claim 14, wherein the pin member comprises two or more pin grooves and wherein the canted spring is positionable in any one of the two or more pin grooves.

16. The method of claim 14, wherein the pin groove comprises a sloped recessed section extending between a pair of adjacent flanges.

17. The method of claim 14, wherein the pin groove comprises a recess of uniform diameter extending between a pair of adjacent flanges.

18. The method of claim 14, wherein the pin member further comprises a frustoconical section at a distal end.

19. The method of claim 18, wherein the pin groove is positioned proximally of the frustoconical section.

20. The method of claim 14, further comprising: positioning a third object between the first and second objects such that the third object is engaged only by the first and second objects and consequently held fast by the fastening together of the first and second objects.

21. The method of claim 20, wherein the third object is an article of bone.

22. The method of claim 14, wherein the mating housing is at least one of attached to and integrally formed with one of the first and second objects.
